(19) United States
(12) Patent Application Publication
(10) Pub. No.: US 2026/0202794 A1
(43) Pub. Date: Jul. 16, 2026

(54) FIELD-DEPENDENT ABERRATION CORRECTION IN COHERENT IMAGING, IN PARTICULAR DIGITAL HOLOGRAPHY

(71) Applicant: Carl Zeiss AG, Oberkochen (DE)

(72) Inventors: Dirk SEIDEL, Jena-Leutra (DE); Matthias WALD, Jena (DE)

(73) Assignee: Carl Zeiss AG, Oberkochen (DE)

(21) Appl. No.: 19/136,340

(22) PCT Filed: Dec. 4, 2023
(86) PCT No.: PCT/EP2023/084065

§ 371 Date: Jun. 6, 2025

(30) Foreign Application Priority Data
Dec. 8, 2022 (DE) 10 2022 132 664.0

(51) Int. Cl. G03H 1/08; G03H 1/00; G03H 1/04

(52) U.S. Cl. CPC G03H 1/0866; G03H 1/0005; G03H 1/0443; G03H 1/0486; G03H 2001/005; G03H 2001/045; G03H 2001/0454

(57) ABSTRACT

Various examples of the disclosure relate to coherent imaging techniques such as digital holography or Fourier ptychography. Aberrations are corrected. The aberrations are corrected according to the field location.

The present application is a National Phase patent application of PCT Appl No. PCT/EP2023/084065, filed Dec. 4, 2023, which claims priority from German Patent Appl. No. DE102022132664.0, filed on Dec. 8, 2022, each of which is hereby fully incorporated herein by reference.

### FIELD OF THE INVENTION

Various examples of the disclosure relate to methods for imaging by means of an optical imaging system, which is configured for the coherent measurement of a sample object with amplitude information and phase information. Several examples relate to digital holography. A number of examples relate in particular to aberration correction in digital holography.

### BACKGROUND OF THE INVENTION

Digital holography is a coherent imaging method that allows the reconstruction of the complex-valued image field of an object. Due to the coherent relationship between the image field and the exit pupil, the complex-valued field in the exit pupil of the imaging system is hence also known.

This property allows a number of interesting manipulations of digital holograms, such as digital refocusing or the compensation of optical image errors. This is described in: Myung K. Kim, “Principles and techniques of digital holographic microscopy,” SPIE Rev. 1 (1) 018005 (Apr. 1, 2010).

Image errors in the holographic image representation not only lead to a dis-turbed visualization of the object, but also introduce quantitative errors in the image phase, which, for example, leads to errors in a surface or thickness metrology based on the measured phase of the sample object.

This also applies to other imaging methods that coherently measure a sample object with amplitude information and phase information. An example of another imaging method would, for example, be Fourier ptychography. See, for example, Tian, Lei, and Laura Waller. “Quantitative differential phase contrast imaging in an LED array microscope.” Optics express 23.9 (2015): 11394-11403. See also Song, Pengming, et al. “Full-field Fourier ptychography (FFP): Spatially varying pupil modeling and its application for rapid field-dependent aberration metrology.” APL Photonics 4.5 (2019): 050802.

Alexander Stadelmaier and Jürgen H. Massig, “Compensation of lens aberrations in digital holography,” Opt. Lett. 25, 1630-1632 (2000) techniques, for example, are known for reducing aberrations in digital holography. The techniques described there have a limited accuracy.

### SUMMARY OF THE INVENTION

Therefore, there is a need for improved techniques for digitally correcting aberrations in imaging methods with quantitative phase information.

A method is disclosed with which, in a coherent imaging method, the field-independent and the field-dependent image errors (aberrations) can be measured and then removed by calculation from a measured object field.

The techniques disclosed herein may be used, for example, in digital holography or Fourier ptychography.

A computer-implemented method for imaging by means of an optical imaging system is disclosed. The optical imaging system is configured for the coherent measurement of a sample object with amplitude information and phase information. The method comprises controlling the optical imaging system in order to measure the pupil function of an imaging optical unit of the optical imaging system by means of a calibration object at a plurality of discrete field positions in the course of a calibration process. The method also comprises determining a steady and continuous representation of the pupil function in dependence on the field position based on the pupil function measured in the plurality of discrete field positions. Furthermore, the method comprises controlling the optical imaging system to measure the sample object. Based on the measurement of the sample object, an image of the sample object is reconstructed taking into account the steady and continuous representation of the pupil function.

A two-stage method is thus disclosed. First, the calibration and then the measurement of the sample object is performed. The calibration uses a calibration object that enables the measurement of the pupil function. The calibration object is different from the sample object. The calibration object has properties that make it possible to measure the pupil function.

The pupil function describes the change in the complex amplitude of a light source after imaging by an optical system at a specific location. The pupil function is related to the point spread function. The point spread function is used to describe the intensity distribution of the image, generated by an optical system, of a point-shaped object that is located on the optical axis. The point spread function is the square of the absolute value of the normalized Fourier transform of the pupil function of the imaging optical system.

Therefore, a point-shaped object or a plurality of point-shaped objects are used as the calibration object in examples. In practice, point-shaped means a particularly small object (e.g. with a diameter smaller than the resolution limit of the optical system).

The plurality of discrete field positions correspond to the different positions of the point-shaped object perpendicular to the optical axis (different lateral positioning). This corresponds to specific support points at which the pupil function is measured.

The steady and continuous representation of the pupil function corresponds to an interpolation between the different support points at the plurality of discrete field positions.

By using a steady and continuous representation of the pupil function, a more accurate and numerically easy-to-use reconstruction of the image of the sample object can be carried out, taking into account the pupil function.

The features set out above and features that are described hereinbelow may be used not only in the corresponding combinations explicitly set out, but also in further combinations or in isolation, without departing from the scope of protection of the present invention.

### BRIEF DESCRIPTION OF THE DRAWINGS

FIG. 1 schematically illustrates a system having a data processing device and an optical imaging system, designed as a microscope, for the coherent measurement of a sample object with amplitude information and phase information according to various examples.

FIG. 2 is a flowchart of one exemplary method.

FIG. 3 illustrates a simulated pupil function with aberrations at a specific field position.

FIG. 4 illustrates basic functions of a principal component analysis of the field-dependent pupil function from FIG. 3 to the third order.

FIG. 5 illustrates the absolute value of the coefficients of the basic functions from FIG. 4.

FIG. 6 illustrates the image field, simulated with the pupil function from FIG. 4, for a calibration object with a plurality of point-shaped stops according to various examples.

FIG. 7 illustrates the pupil function measured using the image field from FIG. 6 at a specific field position according to various examples.

FIG. 8 illustrates the image field of a sample object when imaged by means of the pupil function according to FIG. 3.

FIG. 9 illustrates the corrected image field according to various examples.

### DETAILED DESCRIPTION OF THE INVENTION

The properties, features and advantages of this invention described above and the way in which they are achieved will become clearer and more clearly understood in association with the following description of the exemplary embodiments which are explained in greater detail in association with the drawings.

The present invention is explained in greater detail below on the basis of pre-ferred embodiments with reference to the drawings. In the figures, identical reference signs denote identical or similar elements. The figures are schematic representations of various embodiments of the invention. Elements illustrated in the figures are not nec-essarily illustrated as true to scale. Rather, the various elements illustrated in the figures are rendered in such a way that their function and general purpose become compre-hensible to a person skilled in the art. Connections and couplings between functional units and elements illustrated in the figures may also be implemented as an indirect connection or coupling. A connection or coupling may be implemented in a wired or wireless manner. Functional units may be implemented as hardware, software or a combination of hardware and software.

The following text describes techniques for coherent imaging with amplitude information and phase information for a sample object. For example, digital holography or Fourier ptychography could be used as imaging methods.

In particular, techniques for reconstructing an image of a sample object based on the measurement of the sample object by means of the corresponding imaging tech-nique are described below. The reconstruction is based on the consideration of information about one or more aberrations of the optical imaging system, so that the influ-ence of the one or more aberrations on the reconstructed image can be reduced. The image is obtained with a relatively high quality, and image artefacts due to imperfection of the optical imaging system are reduced.

The techniques disclosed herein are based on a calibration with a corresponding calibration object.

For example, the calibration could be performed immediately prior to the measurement of the sample object. It is also conceivable that the calibration is performed once for a specific optical set-up of the optical imaging system. For example, the calibration could be performed in a final line test during production.

In the course of the calibration process, the pupil function of the imaging optical unit of the optical imaging system is measured by means of the calibration object.

Let O(x, y) be the (generally complex-valued) object transmission distribution (or reflection distribution) of the light and P(f, g) be the imaging pupil function of the imaging optical unit, which includes the numerical aperture (NA) of the exit pupil and also the image errors of the imaging optical unit. The electric field in the sensor plane/image plane with coherent imaging (e.g. digital holography) is then given by

$$E ( {x}^{′} , {y}^{′} ) = {ℱ}^{- 1} [ ℱ ( O ( x , y ) ) \cdot P ( f , g ) ] \qquad ( 1 )$$

x, y and x′, y′ are coordinates in real space. f, g are coordinates in a pupil plane. [symbol] is the Fourier transformation; [symbol] ⁻¹ is the inverse Fourier transformation.

This electric field (which corresponds to the imaging of the object into the sensor plane, also called the image field) is accessible in particular by digital holography. Reconstruction is performed from the measured variables; the specific reconstruction method-based on the measured interferogram or interference pattern between the object wave and the reference wave—can be realized according to reference techniques, see, e.g., Myung K. Kim, “Principles and techniques of digital holographic microscopy,” SPIE Rev. 1 (1) 018005 (Apr. 1, 2010). Typically, a CMOS or CCD sensor is used to measure the interference pattern between the object wave (sample beam) and the reference wave (reference beam). The image field can then be reconstructed from the interference pattern; a process known as numerical diffraction. The image field is also accessible by other coherent imaging methods, e.g. by Fourier ptychography.

First, the calibration process is described. This is used to measure pupil function P(f,g).

In the course of the calibration process, a calibration object is measured. The calibration object may comprise at least one point-shaped contrast object, e.g. at least one point-shaped opening or at least one point-shaped stop.

If a small, point-shaped opening is selected as an object structure for the calibration, its spectrum [symbol] [O(x, y)] is a very weakly varying function of f and g, which is also generally known. Small means here that the diameter is of the order of magnitude of the resolution limit of the optical system. For a circular opening, for example, there is the central part of an Airy function, for rectangular openings, there is the central part of a sinc function. See also Table 1 further below.

It follows that the complex-valued pupil function P(f, g) within the aperture of the imaging optical unit can be obtained from the reconstructed image field E(x′, y′) and the known object spectrum of the calibration object as:

$$P ( f , g ) = \frac{ℱ [ E ( {x}^{′} , {y}^{′} ) ]}{ℱ [ O ( x , y ) ]} , \qquad ( 2 )$$

$$( f , g ) ∈ NA$$

The specific image errors of the system can then (in a conventional way) be obtained from a decomposition of the phase of P(f, g) into basic Zernike functions Zₖ(f, g):

$$arg [ P ( f , g ) ] = {\sum }_{k = 1}^{N} {c}_{k} {Z}_{k} ( f , g ) \qquad ( 3 )$$

In other words, this means that if the pupil function is known, the field profile of one or more aberrations of the imaging optical unit can be determined based on the basic Zernike functions. This can be useful, for example, in order to estimate the resolution or inaccuracy during the imaging of the sample object. This can be helpful in a quantitative evaluation for the determination of uncertainties or error bars.

If the point-shaped opening of the calibration object is arranged on the optical axis, i.e. in the middle of the image field (x=0, y=0), the pupil function is measured at this field location, i.e. P(f, g; x=0, y=0). By selecting any location (x_{c}, y_{c}) for the point-shaped opening of the calibration object, the pupil function can also be determined for other field locations, and thus the field-dependent pupil function can be determined:

$$P ( f , g ; {x}_{c} , {y}_{c} ) = \frac{ℱ [ E ( {x}^{′} , {y}^{′} ; {x}_{c} , {y}_{c} ) ]}{ℱ [ O ( x , y ; {x}_{c} , {y}_{c} ) ]} , \qquad ( 4 )$$

$$( f , g ) ∈ NA$$

In other words, this means that the pupil function is measured at a plurality of discrete field positions {x_{c}, y_{c}} in the course of the calibration process.

The field-dependent pupil function is connected to the field-dependent complex-valued amplitude point spread function (APSF) via a Fourier transformation:

$$APSF ( x , y ; {x}_{c} , {y}_{c} ) = {ℱ}^{- 1} [ P ( f , g ; {x}_{c} , {y}_{c} ) ] \qquad ( 5 )$$

There are a plurality of ways to choose the calibration object or implement the calibration process. Some variants for circular contrast objects are listed in Table 1.

| | |
|---|---|
| 1 | A single point-shaped opening can be moved around in the image |
| | field to measure the field-dependent pupil function one after |
| | the other at a plurality of field positions. The calibration object |
| | can be moved perpendicular to the optical axis in the object plane |
| | in order to obtain the measurement values for the pupil function |
| | at the plurality of field positions in this way. |
| 2 | A calibration object that comprises an array of point-shaped |
| | openings can also be used. This means that a plurality of point- |
| | shaped openings are always imaged in parallel such that the field- |
| | dependent pupil function is measured at a plurality of field positions |
| | simultaneously. |
| | Before applying equation (4), the image representation of all |
| | point-shaped openings must then be blocked out in each case |
| | except for one that is being considered (see further below: FIG. |
| | 6). To enable this, the point structures imaged in the image field |
| | should not overlap. |
| 3 | Instead of a point-shaped opening, the calibration object may also |
| | have one or more point-shaped stops on an otherwise transparent |
| | carrier. This has manufacturing advantages for objects that are |
| | imaged in reflection. |
| 4 | Instead of a point-shaped opening or stop, the object can also be |
| | implemented by the output of one or more optical fibers that are |
| | placed in the object plane. |

Table 1: Various examples of the implementation of a calibration object with one or more point-shaped contrast objects and, connected thereto, of the measurement of the pupil functions at a plurality of discrete field positions.

By means of the preceding calibration process, the pupil function is known at a plurality of discrete field positions, see equation (4).

The following text describes how this expanded knowledge relating to the pupil function—not only at one field position, but at a plurality of field positions—can be used to correct aberrations particularly well. It should first be noted that the correction of field-independent image errors (i.e. for a pupil function that was not determined field-dependently) is known previously, see Jürgen H. Massig, “Compensation of lens aberrations in digital holography,” Opt. Lett. 25, 1630-1632 (2000). The correction according to such reference techniques follows directly from equation (1). The sought undisturbed object field is given by the reconstructed image field by

$$O ( x , y ) = {ℱ}^{- 1} [ \frac{ℱ [ E ( {x}^{′} , {y}^{′} ) ]}{P ( f , g )} ] , \qquad ( 6 )$$

$$( f , g ) ∈ NA$$

If the pupil function has only a phase effect, but no amplitude effect over the range of the NA, the calculation can also be carried out as follows:

$$O ( x , y ) = {ℱ}^{- 1} [ ℱ [ E ( {x}^{′} , {y}^{′} ) ] {P}^{*} ( f , g ) ] , \qquad ( 7 )$$

$$( f , g ) ∈ NA$$

Going beyond these traditional techniques, the correction of field-dependent image errors according to the techniques described herein is described below. This involves interpolation at the pupil function P(f, g; x_{c}, y_{c}) measured at discrete locations. A steady and continuous representation of the pupil function is determined based on a principal component analysis. The principal component analysis is also called Karhunen-Loeve transformation:

$$P ( f , g ; {x}_{c} , {y}_{c} ) = {\sum }_{j = 1}^{∞} {K}_{j} ( {x}_{c} , {y}_{c} ) \cdot {B}_{j} ( f , g ) \qquad ( 8 )$$

In the literature, the method is also known as Proper Orthogonal Decomposition (pod). See Kerschen, G., Golinval, Jc., VAKAKIS, A. F. et al. The Method of Proper Orthogonal Decomposition for Dynamical Characterization and Order Reduction of Me-chanical Systems: An Overview. Nonlinear Dyn 41, 147-169 (2005). In practice, the location dependence of the pupil function is usually a weak and steadily varying function. Therefore, the location-dependent coefficients Kⱼ quickly decrease over j, and it is sufficient to take into account a finite and generally small number M of basic functions Bⱼ:

$$P ( f , g ; {x}_{c} , {y}_{c} ) = {\sum }_{j = 1}^{M} {K}_{j} ( {x}_{c} , {y}_{c} ) \cdot {B}_{j} ( f , g ) \qquad ( 9 )$$

Typically, M is in the range of 5 to 10. Even such a development up to the fifth or tenth order shows a high accuracy in the aberration correction.

Furthermore, the steady location dependency allows an interpolation of the co-efficient matrix Kⱼ(x_{c}, y_{c}) to a finer spatial grid, e.g. the target grid (x, y) of the image recording:

$${\hat{K}}_{j} ( x , y ) = interpol [ {K}_{j} ( {x}_{c} , {y}_{c} ) ] \qquad ( 10 )$$

The correction of field-dependent image errors is achieved by a backward propagation of the measured complex image field E(x′, y′) through the complex conjugated field-dependent pupil function (which indeed reverses the phase effect of the Zernikes). From equations (7) and (9) follows for the object field:

$$O ( x , y ) = {\sum }_{j = 1}^{M} {\hat{K}}_{j}^{*} ( x , y ) \cdot {ℱ}^{- 1} [ ℱ [ E ( {x}^{′} , {y}^{′} ) ] {B}_{j}^{*} ( f , g ) ] , \qquad ( 11 )$$

$$( f , g ) ∈ NA$$

This result for the corrected field is now the appropriate signal for a quantitative phase or height evaluation of the given object. For example, a quantitative phase image of the sample object can be output.

Furthermore, the forward calculation of a holographic recording, with field-dependent image errors, follows from (1) and (9):

$$E ( {x}^{′} , {y}^{′} ) = {\sum }_{j = 1}^{M} {\hat{K}}_{j} ( x , y ) \cdot {ℱ}^{- 1} [ ℱ [ O ( x , y ) ] {B}_{j} ( f , g ) ] , \qquad ( 12 )$$

$$( f , g ) ∈ NA$$

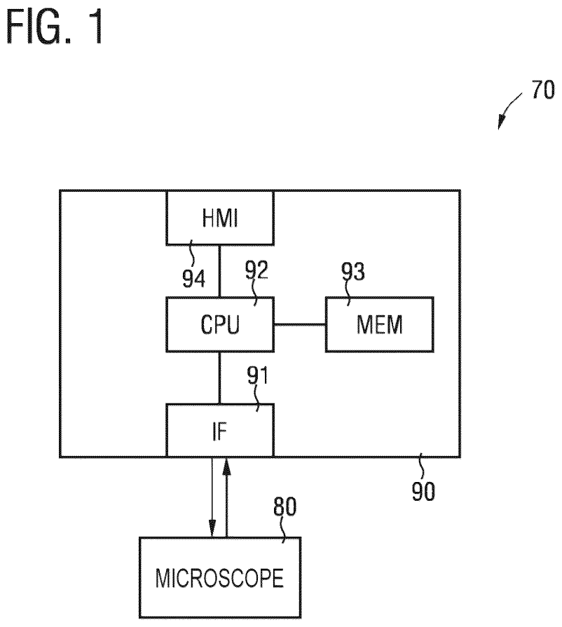

FIG. 1 schematically illustrates a system 70 comprising a data processing device 90 and a microscope 80.

The microscope 80 may, for example, be a digital holographic microscope, which records an interference pattern between a sample beam and a reference beam from a coherent light source, e.g. a laser, by means of a detector. An interferometric image representation can be generated. A Mach-Zehnder interferometer or a Michelson interferometer can be used.

It would also be possible for the microscope to be a digital Fourier ptychography microscope, which has in the illumination pupil plane an illumination module with a plurality of coherent light sources, which can be individually switched on and off. Thus, a plurality of intensity images can be acquired with oblique illumination and, based on these plurality of intensity images, the phase of the object can then be quantitatively reconstructed.

The microscope 80 can provide corresponding measurement data to an interface 91 of the data processing device 90. A processor 92 can process the corresponding measurement data. To this end, the processor 92 can load program code from a memory 93 and execute it. More generally, executing the program code from the memory 93 causes the processor 92 to perform techniques as described herein, for example: controlling the microscope 80, in which control data are sent via the interface 91; performing a calibration process; measuring a pupil function at a plurality of discrete field positions; determining a steady and continuous representation of the pupil function; controlling the microscope 80 to measure a sample object or calibration object; reconstructing an image of the sample object using a reconstruction algorithm, such as a numerical diffraction algorithm in connection with digital holography or a Fourier-ptychography reconstruction algorithm; etc.

Some general aspects of digital holography are explained below. In digital holography, the holographic interference pattern is optically generated by superposing object beams and reference beams, which are digitally scanned by a camera (e.g. CCD camera) and transmitted as a series of numbers to a computer. The interference between the object beam and the reference beam thus creates an interference pattern, which is also called a hologram. The interference pattern contains both the amplitude information and the phase information of the object beam, which enables the reconstruction of a three-dimensional image of the object. The propagation (typically fully coherent) of optical fields is described completely and accurately by diffraction theory, which allows a numerical reconstruction of the image as a series of complex numbers representing the amplitude and phase of the optical field.

For example, the reference beam can be obtained as an external reference, i.e. it can be generated separately from the object beam or split off from the object beam before the object is illuminated. For example, a Michelson interferometer set-up or a Mach-Zehnder interferometer set-up can be used to generate the interference pattern. In the Michelson interferometer, the incident light beam is split at a beam splitter into two paths. One of these paths illuminates the object (object beam), while the other serves as a reference beam. After reflection or transmission, the two beams are recombined at the beam splitter, where they interfere. The Mach-Zehnder interferometer works similarly, but with a different arrangement of the optical components: Here, the object beam and the reference beam are spatially separated and guided along different sections before they are recombined to generate the interference pattern. However, it would also be possible to couple the reference beam into the object beam by means of an optical fiber, whereby the beam splitter and beam combiner can be avoided. This allows for a compact and robust design to be achieved.

The following text describes details relating to techniques that can be performed by the processor 92.

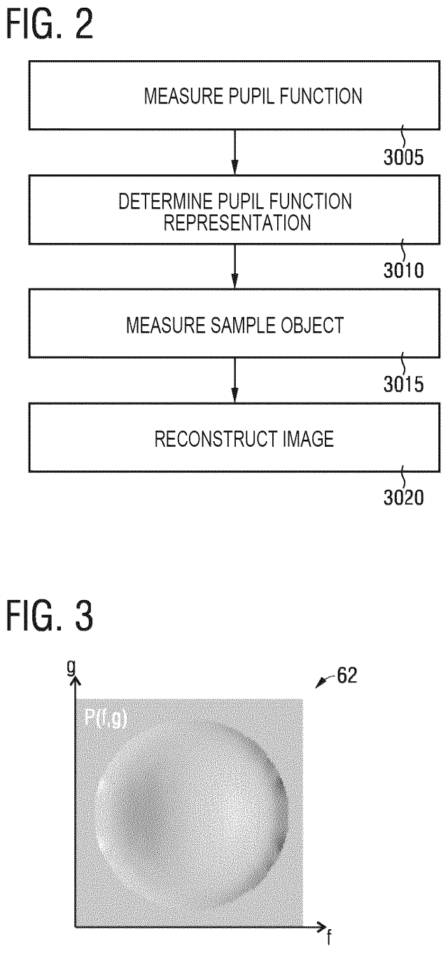

FIG. 2 is a flowchart of one exemplary method. The method from FIG. 2 is computer-implemented, that is, it can be performed, for example, by a data processing device such as, for example, the data processing device 90 from FIG. 1. The method from FIG. 2 is used for imaging by means of an optical imaging system, such as the microscope 80 from FIG. 1. In particular, a coherent measurement of a sample object with amplitude information and also with phase information can be achieved. Aberration correction can be made possible.

In box 3005, the optical imaging system is controlled to measure the pupil function of an imaging optical unit of the optical imaging system by means of a calibration object in the course of a calibration process at a plurality of discrete field positions. Examples of calibration objects were discussed above in the context of Table 1. The measurement of the pupil function at the different discrete field positions was described above in connection with equation (4).

Box 3010 then involves determining a steady and continuous representation of the pupil function in dependence on the field position based on the pupil function measured in the plurality of discrete field positions. For example, an interpolation between the measured support points can take place. A principal component analysis can be performed; corresponding techniques have been described above in connection with equation (9).

Then the pupil function of the optical imaging system is known. This pupil function includes the aberrations. For example, it would be conceivable that, based on the continuous and steady representation of the pupil function, a field profile of at least one of the aberrations of the imaging optical unit is quantified. Corresponding techniques were described above in connection with equation (3), where the decomposition of the phase of the pupil function into basic Zernike functions was discussed. The components of the various basic Zernike functions are indicative of the respective strength of the associated aberration.

The sample object can then be measured in box 3015. This means that the calibration object is removed from the microscope beam path; instead, the sample object is placed in the beam path.

It would then be conceivable, for example, that the measurement signal for the sample object is corrected with regard to these aberrations. The image of the sample object can then be reconstructed in box 3020 after the measurement signals have been corrected. In particular, in connection with digital holography, a scenario was described in which the object field for the sample object is determined based on a backward propagation of the image field (which is conventionally reconstructed) from the detector plane to the object plane using the inverse of the continuous representation of the pupil function. This has been described in connection with equation (11).

An example implementation is described below using a simulation of a digital holographic image representation. A field-dependent coma curve and a field-dependent image field curvature (as an example of an aberration) are modeled. The pupil function is given by the corresponding Zernike description of coma and sphere at eleven field locations (xₙ, y=0), n=1 . . . 11, along the x-axis (lateral, perpendicular to the optical axis which is oriented in the z-direction). FIG. 3 shows an example of the phase 62 of the pupil function used for the simulation for a position at the edge of the field.

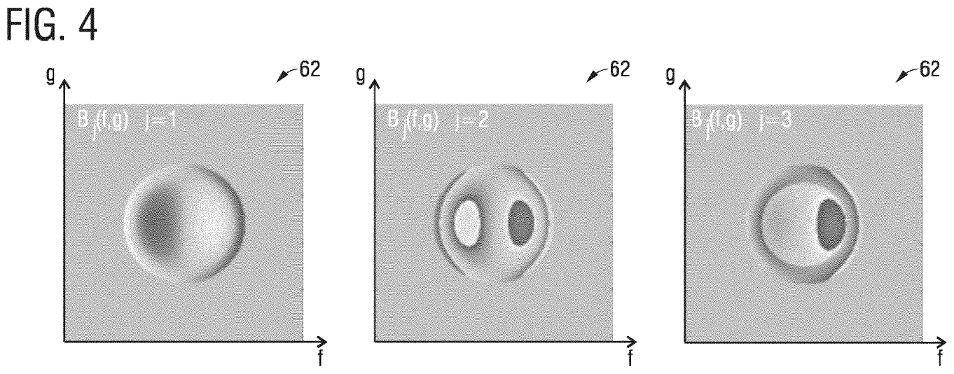

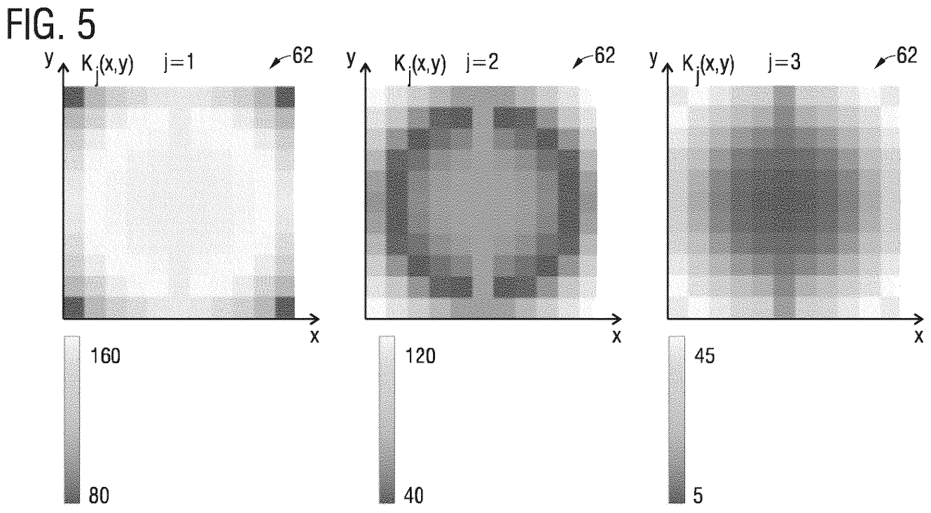

The corresponding Karhunen-Loeve decomposition (principal component analysis) of this field-dependent pupil is shown in FIG. 4 and FIG. 5. FIG. 4 shows in detail the phase 62 of the first three basic functions (j=1,2,3) of the principal component analysis; and FIG. 5 shows the absolute values of the coefficients of the principal component analysis (|Kⱼ| in equation (8)) for different field positions (at a comparatively low lateral resolution; the latter can be increased by interpolation). In FIG. 5, the leg-ends show the assignment of the values of the plotted absolute values of the components of the principal component analysis to grey levels. It can be seen that the absolute values decrease from j=1 to j=3 (from approx. 160 to 45). This corresponds to the finding that only a limited number of principal components (up to approx. M=5 or M=10) need to be taken into account for an exact consideration (moreover, the coefficients are so small that they can be neglected).

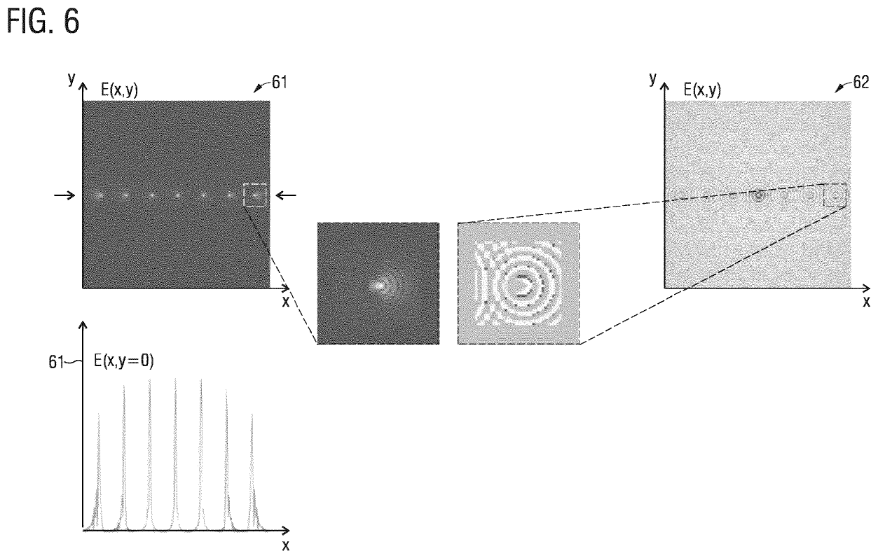

Now, by means of equation (12), the holographic image field can be simulated, which would have been measured by the holographic reconstruction of an interferogram recorded with an optical system with the given field-dependent image errors (if the aberrations are present). Seven pinholes on the x-axis with a diameter below the resolution limit of the used optical unit are selected as the object structure, which scan the field-dependent image errors on the x-axis. This thus corresponds to a calibration object with a 1×7 array of point-shaped openings; see Table 1: Example 2. The corresponding image field is shown in FIG. 6—which is obtained by the imaging with a field-dependent coma and field-dependent image field curvature—(specifically the amplitude 61 and the phase 62; and a line plot of the amplitude at y=0).

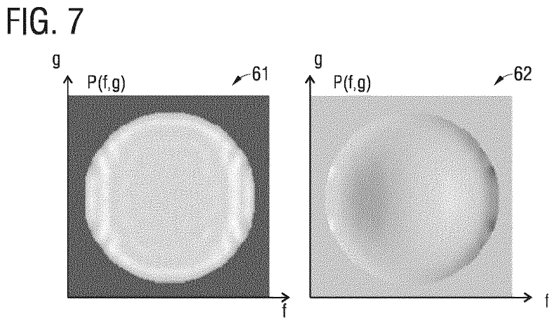

From the simulated image field shown in FIG. 6, the field-dependent pupil function can be obtained by cutting out the point image representations (inset in FIG. 6 and dashed squares; the trim is shown in FIG. 6 as an example of an individual position at the edge of the field, but will be repeated for all seven point image representations to obtain a plurality of support points for the pupil function) and Fourier transformation. The pupil function measured based on the cutout of the image representation of the corresponding point image representation in FIG. 6 is shown in FIG. 7. It is apparent from comparing FIG. 3 (“ground truth”) with FIG. 7 (scanning of the pupil function) that the pupil function can be measured in a good approximation in this way.

The pupil function can thus be determined at a plurality of support points (at different field positions). Then a principal component analysis can be performed. Then the calibration is complete.

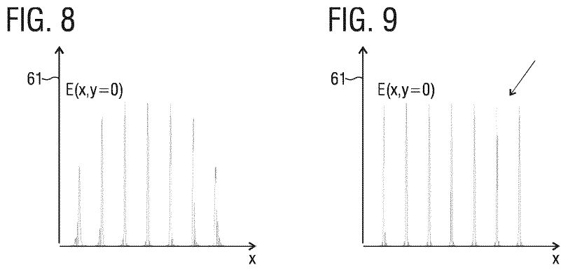

FIG. 8 and FIG. 9 show examples of the “reverse” of the calculation. If the field-dependent pupil function is known from such a calibration step, any sample object can be corrected field-dependently, as described above. FIG. 8 and FIG. 9 show this. The image field of a series of points, shown with image field curvature and coma (FIG. 8), can be corrected by the backward propagation according to equation (11) by the conjugated or inverted pupil function. In particular, for example the deviations in the image field between the image representation and the actual object at the edge of the field are specifically shown in FIG. 9 using the arrow.

It goes without saying that the features of the embodiments and aspects of the invention described above may be combined with one another. In particular, the features may be used not only in the combinations described but also in other combinations or on their own, without departing from the scope of the invention.

The techniques have been described above in connection with aberration correction, in particular for imaging by digital holography. However, such techniques are also conceivable for other coherent imaging methods, such as ptychography, Fourier ptychography, or iterative methods, such as Gerchberg-Saxton.

1. A computer-implemented method for imaging by means of an optical imaging system, which is configured for the coherent measurement of a sample object with amplitude information and phase information,
wherein the method comprises:
controlling the optical imaging system in order to measure the pupil function of an imaging optical unit of the optical imaging system by means of a calibration object at a plurality of discrete field positions in the course of a calibration process,
based on the pupil function measured at the plurality of discrete field positions: determining a steady and continuous representation of the pupil function in dependence on the field position,
controlling the optical imaging system to measure the sample object, and
based on the measurement of the sample object, reconstructing an image of the sample object taking into account the steady and continuous representation of the pupil function.

2. The computer-implemented method as claimed in claim 1,
wherein the steady and continuous representation of the pupil function is determined based on a principal component analysis of the pupil function measured at the plurality of discrete field positions.

3. The computer-implemented method as claimed in claim 1,
wherein the optical imaging system is a digital holographic microscope, which is configured to record an interference pattern between a sample beam and a reference beam by means of a detector.

4. The computer-implemented method as claimed in claim 1,
wherein reconstructing the image of the sample object comprises:
determining an object field for the sample object based on a backward propagation of an image field, captured during the measurement of the sample object, from a detector plane to an object plane using an inverse of the continuous representation of the pupil function.

5. The computer-implemented method as claimed in claim 3,
wherein the method furthermore comprises:
determining the image field based on the interference pattern using techniques of digital holography.

6. The computer-implemented method as claimed in claim 1,
wherein the calibration object comprises at least one point-shaped contrast object.

7. The computer-implemented method as claimed in claim 6,
wherein the at least one point-shaped contrast object comprises at least one of at least one point-shaped opening or at least one point-shaped stop.

8. The computer-implemented method as claimed in claim 1,
wherein the calibration process comprises the arrangement of the calibration object in an object plane and at a plurality of positions perpendicular to the optical axis of the imaging optical unit in order to obtain measurement values for the pupil function at the plurality of field positions in this way.

9. A method as claimed in claim 1, wherein the method furthermore comprises:
based on the continuous and steady representation of the pupil function: quantifying a field profile of at least one aberration of the imaging optical unit.

10. The method as claimed in claim 1,
where the image is a quantitative phase image of the sample object.

11. An apparatus comprising at least one processor and a memory, wherein the at least one processor is configured to load program code from the memory and to execute the program code,
wherein the at least one processor is configured to perform the computer-implemented method as claimed in claim 1, based on the execution of the program code.
